(19) United States
(12) Patent Application Publication
(10) Pub. No.: US 2008/0278401 A1
(43) Pub. Date: Nov. 13, 2008

(54) ANTENNA STRUCTURE FOR A NOTEBOOK

(76) Inventor: Yao-Wen YU, Pa-Te City (TW)

Correspondence Address: SINORICA, LLC, 528 FALLSGROVE DRIVE, ROCKVILLE, MD, 20850, US

(21) Appl. No.: 11/746,678

(22) Filed: May 10, 2007

(51) Int. Cl. H01Q 1/12

(52) U.S. Cl. 343/878

(57) ABSTRACT

An antenna structure for a notebook with four radiation members, the antenna structure has an elongate supporting rack having thereon a first radiation member, a second radiation member, a third radiation member and a fourth radiation member; each radiation member is planar, and is integrally connected with the supporting rack. Thereby, when the notebook uses a plurality of antennas, the costs of mold developing and time for processing can be reduced, and in designing, the space of the antenna will not waste by having the structure, and a better effect in function can be obtained.

### BACKGROUND OF THE INVENTION

1. Field of the Invention

The present invention relates to an antenna structure, and especially to an antenna structure which suits a notebook applied to multi-frequency wireless communication.

2. Description of the Prior Art

In fast progression of the technique of wireless communication, such as wireless local area network (LAN), gradually, mobile communication systems have been built in notebooks; thereby the notebooks can still be connected with the outside for transmitting data via the mobile communication systems. The working frequencies of the technique of wireless communication have developed to multi-frequencies very early before, such as VIFI, GSM 900, GSM 1800, DCS, CDMA and WCDMA etc.

In an US Patent Application no. 20,070,060,222 titled “Combination Antenna with Multiple Feed Points”, there is a kind of combination antenna having therein a common structure for connecting a first electromagnetic radiation element and a second electromagnetic radiation element, the two electromagnetic radiation elements are provided for operating different frequency bands. The common structure includes a common antenna structure, a common mounting structure and a common grounding structure, in order that the space occupied by the first and the second electromagnetic radiation elements which are mounted separately can be saved.

The evidently not able to satisfy the requirement of mobile communication. And more, by virtue of the tendency of compacting of notebooks, the space for mounting hidden antenna becomes smaller and smaller; it is the main category of discussion of the present invention—how to design an antenna structure that can be applied to multiple frequency bands.

### SUMMARY OF THE INVENTION

The present invention mainly is to provide an antenna structure for a notebook with four radiation members, the antenna structure has an elongate supporting rack having thereon a first radiation member, a second radiation member, a third radiation member and a fourth radiation member; each radiation member is planar, and is integrally connected with the supporting rack. Thereby, under space allowance of the notebook, for instance, above the screen, it is capable to mount a multi-frequency antenna structure at one time in a space saving mode; and this can make saving of cost and processing.

In the antenna structure provided for the present invention, at least two of the first to the fourth radiation members are of same working frequency, for instance, the frequencies of the first and the fourth radiation members are same, or the frequencies of the second and the third radiation members are same, but alternatively, they can be all different.

The antenna structure of the present invention not only can save the costs of mold developing and time for processing, but also can save space occupied in comparison with that having four radiation members mounted separately, the space of the antenna will not waste by having the structure, and a better effect in function can be obtained.

The present invention will be apparent in its structure and operational function after reading the detailed description of the preferred embodiment thereof in reference to the accompanying drawings.

### BRIEF DESCRIPTION OF THE DRAWINGS

FIG. 1 is a perspective view showing the appearance of the present invention;

FIG. 2 is a plan view of the present invention;

FIG. 3 is schematic view showing use of the present invention on a notebook;

FIG. 4 is a plan view of another embodiment of the present invention.

### DETAILED DESCRIPTION OF THE PREFERRED EMBODIMENT

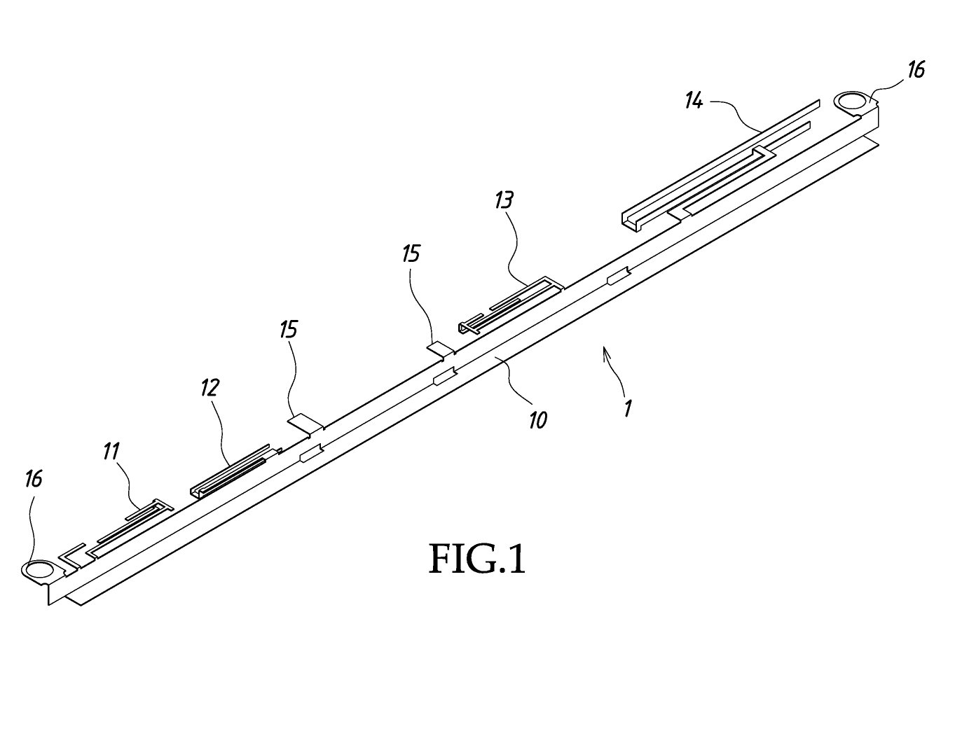

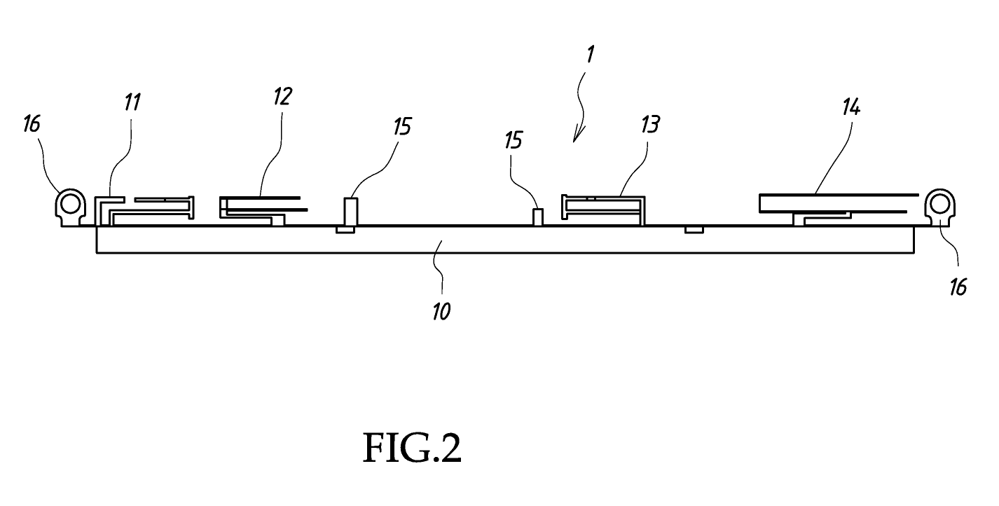

Referring to FIGS. 1 and 2, an antenna structure 1 of the present invention comprises an elongate supporting rack 10 having thereon a first radiation member 11, a second radiation member 12, a third radiation member 13 and a fourth radiation member 14; the radiation members 11-14 are all planar, and are integrally connected with the supporting rack 10.

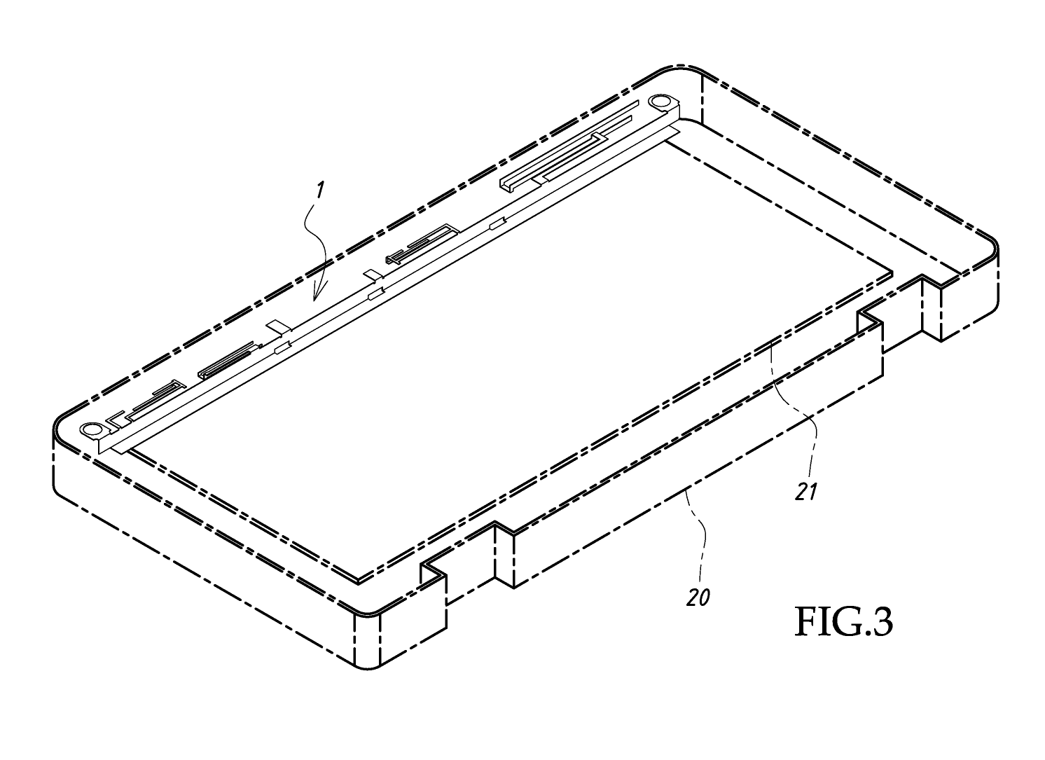

A plurality of fixing hooks 15 are extended out of the supporting rack 10 which has two screw fixing holes 16 provided on the two mutually opposite ends thereof for locking in of screws for the convenience of mounting the supporting rack 10 above a displaying screen 21 of a notebook 20, as is shown in FIG. 3.

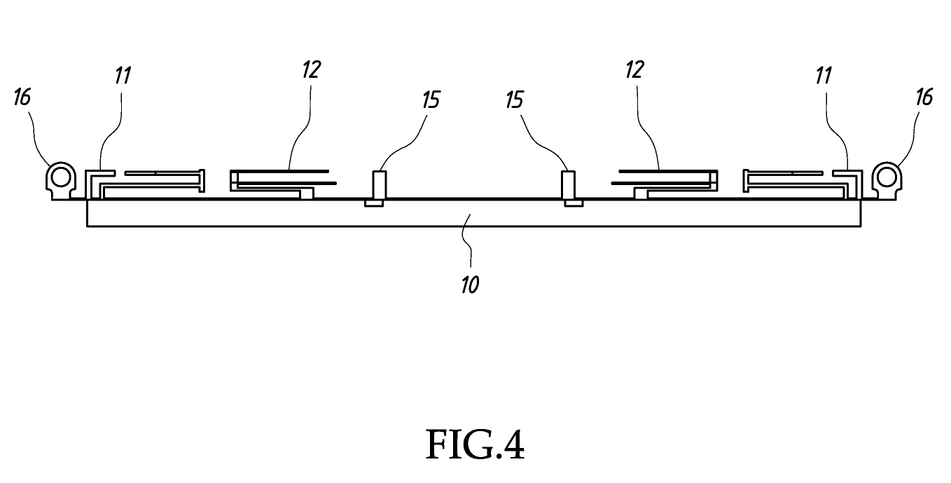

In this embodiment, the first to the fourth radiation members 11-14 are of different working frequencies. FIG. 4 shows another embodiment of the present invention, wherein the first and the fourth radiation members 11, 14 are of same working frequency such as WIFI; and the second and the third radiation members 12, 13 are also of same working frequency such as GSM and WCDMA.

The fourth radiation members 11-14 of the present invention are integrally connected with the supporting rack 10, and a multi-frequency antenna structure can be made just with a set of mold, this can have an effect of saving space as in comparison of the present invention with the mode of having four radiation members formed and mounted separately, and can meet the tendency of compacting of notebooks. Moreover, it is capable to mount the multi-frequency antenna structure at one time; and this can make saving of time of processing in comparison with the mode of forming and mounting separately.

Having now particularly described and ascertained the novelty and improvement of my invention and in what manner the same is to be performed, what we claim will be declared in the claims followed.

1. An antenna structure for a notebook with four radiation members, said antenna structure comprises an elongate supporting rack having thereon a first radiation member, a second radiation member, a third radiation member and a fourth radiation member; each of said radiation members is planar, and is integrally connected with said supporting rack.

2. The antenna structure for a notebook with four radiation members as defined in claim 1, wherein at least two of said first to said fourth radiation members are of same working frequency.

3. The antenna structure for a notebook with four radiation members as defined in claim 1, wherein a plurality of fixing hooks are extended out of said supporting rack which has two screw fixing holes provided on two mutually opposite ends thereof for locking in of screws for convenience of mounting said supporting rack above a displaying screen of said notebook.
